(19) United States
(12) Patent Application Publication
(10) Pub. No.: US 2021/0123831 A1
(43) Pub. Date: Apr. 29, 2021

(54) AERODYNAMIC DRAG MONITORING SYSTEM AND METHOD

(71) Applicant: MOTUS DESIGN GROUP LTD., Victoria (CA)

(72) Inventors: Ty Andrews, Calgary (CA); Curran Crawford, Victoria (CA)

(21) Appl. No.: 17/048,821

(22) PCT Filed: Apr. 16, 2019
(86) PCT No.: PCT/CA2019/050464

§ 371 Date: Oct. 19, 2020

(30) Foreign Application Priority Data
Apr. 19, 2018 (CA) 3,002,186

(51) Int. Cl. G01M 9/06

(52) U.S. Cl. CPC G01M 9/06

(57) ABSTRACT

Described are various embodiments of an aerodynamic drag monitoring system and method. In one embodiment, a system is described to comprise a motion sensor and an aerodynamic sensor operable to acquire respective sensor values each associated with a respective sensor noise variance, a digital data storage medium having stored thereon a digital motion dynamic model and preset initialization parameters, and a digital data processor operable to iteratively process measured sensor values against the model to output a predicted value for a predicted aerodynamic drag variable over time while accounting for each sensor noise variance.

### CROSS REFERENCE TO RELATED APPLICATION

This application claims the benefit of priority to Canadian Patent Application No. 3,002,186, filed Apr. 19, 2018 and entitled “Aerodynamic Drag Monitoring System and Method” which is incorporated by reference herein in its entirety.

### FIELD OF THE DISCLOSURE

The present disclosure relates to athletic performance monitoring systems, and, in particular to an aerodynamic drag monitoring system and method.

### BACKGROUND

Athletic performance monitoring systems and devices are commonly used in various athletic disciplines to assist both professional and amateur athletes alike to improve their form, training methods and/or results overall through sensor feedback and data analysis. Equipment testing and development is also routinely subject to these types of analyses.

Cycling is one example of a competitive sport that is increasingly employing sophisticated methods for improving rider performance and bicycle equipment component design. For instance, over the last decade, sensors known as power meters have become increasingly mainstream in the market that directly measure the mechanical power output of a cyclist. While useful, the measure of aerodynamic drag remains challenging if not impossible for most cyclists, for instance, while riding outdoors on open roads either during training or even competition. Yet, aerodynamic drag is critically important because ˜70% of the power a cyclist produces goes into overcoming wind resistance.

Generally, aerodynamic drag is quantified as the product of a drag coefficient and a frontal area, referred to hereinafter as CdA. While equipment such as helmets, wheels and clothing can drastically affect a cyclist's aerodynamic drag, optimizing the aerodynamics of the cyclist's body on the bike is more difficult because of variations in each cyclist's body type, flexibility and overall proportions. Each of these factors affect what body position is optimal for a cyclist to produce maximum power output with minimal drag.

Currently low speed wind tunnels and indoor velodromes are used for testing a rider's position and equipment, but these are not readily accessible to most cyclists. On-road conditions are also significantly different than the highly-controlled conditions of a wind tunnel.

Using the first method, a cyclist is set up in the wind tunnel on a platform which has force sensors to measure the wind resistance on the cyclist; a rolling road is also sometimes used. Different positions, components and equipment are tested with the cyclist on the bike in the wind tunnel, either static or pedaling (note that the bike is rigidly supported, unlike on-road riding where yawing and rolling motion occurs).

The second method uses a controlled environment such as an indoor cycling track with the rider completing numerous laps in one position while recording the rider's output power. After the session, the power and speed results for each position can be analyzed to calculate the aerodynamic drag of the cyclist. This method requires there to be no wind in a flat and enclosed track (i.e. a velodrome). Both methods require very expensive and specialized facilities unavailable to the vast majority of riders.

Another method, referred to herein as the Chung method (R. Chung, “Estimating CdA with a power meter,” March 2012. [ONLINE] See: http://anonymous.coward.free.fr/wattage/cda/indirect-cda.pdf) is derived from a balance of forces on the cyclist while riding a closed loop on open roads to retroactively calculate the aerodynamic drag of a cyclist. This method uses the measured power input from a power meter along with speed and elevation sensors to develop a “virtual elevation profile” of the circuit ridden on open roads by the cyclist. By adjusting the coefficient of drag, the virtual elevation profile can be model-fitted by lining up the virtual elevation of the start and end of each lap to be the same (i.e. zero net elevation change, as required on a loop). While useful, the Chung method does not provide real-time analysis and output of aerodynamic drag, nor is it applicable to open road applications, i.e. it only works on a closed loop with post-processing. It is also sensitive to ambient gust wind conditions.

A similar method was described in International Application Publication No. WO 2017/055759, in which travel speeds are measured for different round trips on the same route and aerodynamic drag surface and/or the coefficient of rolling of the vehicle are calculated therefrom. Again, this approach fails to translate to open road and real-time applications.

Yet another technique is described in U.S. Pat. No. 9,188,496, in which a system and method for calculating aerodynamic drag action on a rider on a vehicle under changing conditions is described to include sensors between every point of contact between the rider and vehicle so to measure and calculate a relative drag force applied to the user relative to the vehicle. In this case, real-time and open road applications may be considered, however, implementation may require a number of sensors to be aptly worn or disposed at each rider/vehicle interface to produce reliable results.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for an aerodynamic drag measurement system and method that overcome some of the drawbacks of known techniques, or at least, provides a useful alternative thereto. Some aspects of this disclosure provide examples of such systems and methods.

In accordance with one aspect, there is provided a system comprising a motion sensor and an aerodynamic sensor operable to acquire respective sensor values each associated with a respective sensor noise variance, a digital data storage medium having stored thereon a digital motion dynamic model and preset initialization parameters, and a digital data processor operable to iteratively process measured sensor values against the model to output a predicted value for a predicted aerodynamic drag variable over time while accounting for each sensor noise variance.

In accordance with one aspect, there is provided a system for monitoring aerodynamic drag variations in line with a user's path of motion, the system comprising: a motion sensor and an aerodynamic sensor fixedly mountable in relation to the user and operable to each measure a respective sensor value representative of a motion of the user and a local airflow over time, wherein each said sensor value is associated with a respective sensor noise variance; a digital data storage medium having stored thereon: a digital motion dynamic model for the user in motion, wherein said model defines respective measured input variables associated with each said sensor value and a predicted aerodynamic drag variable at least partially predictable from said respective measured input variables via said model; and preset initialization parameters representative of the system and at least comprising a stored value representative of each said respective sensor noise variance; a digital data processor operable to iteratively process each said measured sensor value against said model to output a predicted value for said predicted aerodynamic drag variable over time while accounting for each said respective sensor noise variance.

In one embodiment, the digital processor is operable to iteratively process said measured sensor value by implementing an Extended Kalman Filter.

In one embodiment, the Extended Kalman Filter is implemented with Directional Tracking.

In one embodiment, the user's path of motion is defined while performing an athletic activity, and the dynamic model is specifically defined for the athletic activity.

In one embodiment, the athletic activity is cycling.

In one embodiment, the dynamic model defines dynamic variables associated with each of rider input power, kinetic energy, rolling resistance, elevation change and aerodynamic drag, and wherein the system comprises multiple sensors each fixedly mountable in relation to the user in motion and operable to produce values representative of a rider power, a user velocity, an inclination and an air velocity.

In one embodiment, the athletic activity is skiing or rowing.

In one embodiment, the dynamic model comprises defined dynamic variables associated with at least each of user input power and aerodynamic drag.

In one embodiment, the system is operable to produce values representative of at least a user power, a user velocity, and an air velocity.

In one embodiment, the system is further operable to produce values representative of an inclination.

In accordance with another aspect, there is provided a computer-readable medium having computer-executable instructions stored thereon to monitor aerodynamic drag variations on a user in motion that, upon implementation by a digital data processor: receives as input a sensor value representative of a displacement of the user in motion over time, wherein said sensor value is associated with a sensor noise variance; iteratively processes said measured sensor value against a digital motion dynamic model for the user in motion, wherein said model defines a measured input variable associated with said sensor value and a predicted aerodynamic drag variable at least partially predictable from said measured input variable via said model, so to output a predicted value for said predicted aerodynamic drag variable over time while accounting for said sensor noise variance.

In one embodiment, the instructions, when implemented by said digital processor, further iteratively process said measured sensor value by implementing an Extended Kalman Filter.

In one embodiment, the Extended Kalman Filter is implemented with Directional Tracking.

In one embodiment, the user's path of motion is defined while performing an athletic activity, and wherein said dynamic model is specifically defined for said athletic activity.

In one embodiment, the athletic activity is cycling, and wherein said dynamic model defines dynamic variables associated with each of rider input power, kinetic energy, rolling resistance, elevation change and aerodynamic drag, and wherein the instructions are implementable to produce values representative of a rider power, a user velocity, an inclination and an air velocity.

In one embodiment, the dynamic model comprises defined dynamic variables associated with at least each of user input power and aerodynamic drag.

In one embodiment, the instructions are operable to produce values representative of at least a user power, a user velocity, and an air velocity.

In accordance with another aspect, there is provided a computer-implemented method, to be implemented by one or more digital processors, to automatically monitor aerodynamic drag variations on a user in motion, comprising: receiving as input a sensor value representative of a displacement of the user in motion over time, wherein said sensor value is associated with a sensor noise variance; and iteratively processing said measured sensor value against a digital motion dynamic model for the user in motion, wherein said model defines a measured input variable associated with said sensor value and a predicted aerodynamic drag variable at least partially predictable from said measured input variable via said model, so to output a predicted value for said predicted aerodynamic drag variable over time while accounting for said sensor noise variance.

In one embodiment, the iteratively processing comprises iteratively processing said measured sensor value by implementing an Extended Kalman Filter.

In one embodiment, the Extended Kalman Filter is implemented with Directional Tracking.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a diagram of various forces and parameters involved in an exemplary embodiment of an aerodynamic drag monitoring system and method when applied to cycling;

FIG. 2 is a diagram of an aerodynamic drag monitoring system, in accordance with one embodiment, when illustratively applied to cycling;

FIG. 3 is a chart comparing filtered speed readings output by an exemplary embodiment of an aerodynamic drag monitoring system, to measured noisy speed readings and an actual velocity;

FIG. 4 is a chart comparing filtered aerodynamic drag values output by an exemplary embodiment of an aerodynamic drag monitoring system, to a modeled constant aerodynamic drag value;

FIG. 5 is a chart comparing filtered aerodynamic drag values output by an exemplary embodiment of an aerodynamic drag monitoring system in the absence of directional filter tracking, to an aerodynamic drag value modeled by a step function, showing a significantly delayed filter response;

FIG. 6 is a chart comparing filtered aerodynamic drag values output by an exemplary embodiment of an aerodynamic drag monitoring system with directional filter tracking, to an aerodynamic drag value modeled by a step function, showing a significantly improved filter response;

FIG. 7 is a chart comparing filtered power values output by an exemplary embodiment of an aerodynamic drag monitoring system without directional filter tracking, to a modeled sinusoidal power function, showing a significantly delayed filter response ultimately stabilizing toward a constant value corresponding to the means of the power function; and

FIG. 8 is a chart comparing filtered aerodynamic drag values output by an exemplary embodiment of an aerodynamic drag monitoring system with directional filter tracking, to a modeled sinusoidal power function, showing a significantly improved filter response, albeit noisier.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

The systems and methods described herein provide, in accordance with different embodiments, different examples of an aerodynamic drag monitoring system and method that can be implemented for cyclists, or athletes in other athletic disciplines like skiing, rowing, etc., for the purposes of dynamically monitoring drag forces applied thereto and, optionally, reporting on such drag forces to encourage or promote changes in user form, positioning, equipment selection or other like parameters to effectively reduce drag and thus improve performance. For simplicity, the following will focus on cycling applications and examples, however, the person of ordinary skill in the art will readily appreciate the similar application of the herein described embodiments to other athletic endeavors where aerodynamic drag may be of concern or consequence.

Using embodiments of the systems and methods as described herein, not only can equipment selection and use be assessed for drag reduction, but also how real-time user and environmental changes can impact their drag coefficient. Namely, changes in the user's form, position, fatigue, output, or like parameters may be dynamically monitored for impact on the user's overall drag conditions, as can environmental conditions be monitored such as road conditions, slope, precipitation, wind speeds, etc.

For instance, in some embodiments, the CdA of a cyclist or like athlete can be monitored in real time and in real world conditions so their aerodynamic performance can be optimized without invoking the limitations of current methods, such as by frequenting a velodrome or wind tunnel, or limiting measurements to the closed loop and post-processing application proposed by the Chung or like method. As will be further detailed below, by modeling a cyclist, or like athlete, mathematically and developing a system of sensors to measure key components, the CdA of the cyclist can be predicted.

Furthermore, the methods as described herein can, in some embodiments, rely on standard sensor equipment, such as rider power meters, inclinometers (slope sensors), air speed sensors, ground speed sensors, or the like, without invoking application-specific sensors, such as for example described in the examples provide in U.S. Pat. No. 9,188,496. Furthermore, as will be appreciated by the skilled artisan, the systems and methods described herein may be configured to operate or interface with sensors of different type, quality, brand and price range given the user budget, for example. Redundant sensor data can also be interchanged or leveraged to accommodate unexpected sensor malfunctions, lost signals, or rather provide for greater overall system accuracy and performance (e.g. speed data can be concurrently or interchangeably acquired from GPS receiver, wheel, and/or cadence/gear sensors).

Some aspects considered in the development of the herein-described embodiments, included, but are not limited to, the non-linear nature of the equation of motion applicable for cyclists, for example, which imposed the development of a more sophisticated set of computational processes. Real-time and real-world conditions applicable in the development of a widely accessible technology also require, in some embodiments, that the CdA computations combine inputs from various sensors (in some embodiments four or more sensors) each providing measurements with non-negligible sensor noise, both in providing robust and accurate results, but also in delivering fast and responsive results for real-time applicability so to clearly influence the athlete's behavior and performance. Again, the use of redundant or overlapping sensor signals may further improve treatment of sensor noise, in some examples.

In one particular embodiment, an Extended Kalman Filter (EKF) with directional tracking was specifically developed that can overcome each of these challenges. For instance, the filtering process was designed to be implemented in real time and to reduce error propagation from noisy sensor readings, such as ground speed sensor readings, air speed sensor readings, slope sensor readings and/or rider power sensor readings to name a few, to the final prediction of CdA. As will be detailed below, one exemplary implementation of the herein-described filter was tested with modeled data sets to track a time varying CdA to within 3% error, for example. Using this filter, a cyclist's CdA can be tracked with sensor noise on each sensor as well as changing CdA and rider power, for example. Accordingly, the use of an EKF as described herein can track the CdA with enough sensitivity and accuracy to be useful to cyclists aiming to refine their aerodynamic position on the bike.

In order to provide accurate CdA monitoring, active sensor data is continuously provided as input into a dynamics model for the activity at hand. For example, in the cycling embodiment described in greater detail herein, a theoretical model was developed to produce realistic data that could be used to model sensor noise as well as changing conditions like slope and wind speed, for example.

For instance, in one example, the dynamics governing cycling can be expressed as follows:

W_{Rider Power}=W_{Roll. Resistance}+W_{Elev. Change}+W_{Kin. Energy}+W_{Aerodyn. Drag}

where the work provided by the rider is equated to the work provided by the rolling resistance, elevation change, aerodynamic drag and kinetic energy.

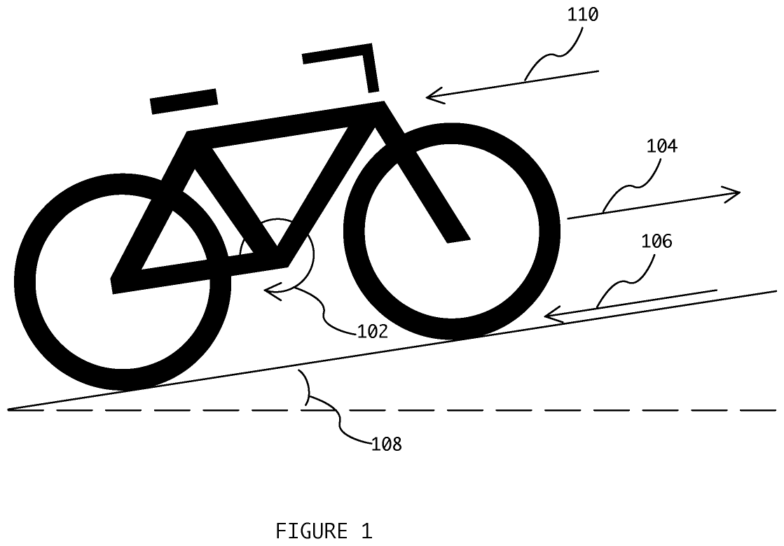

FIG. 1 provides a diagrammatical representation of the various forces/parameters at play in an illustrative cycling embodiment. Generally, the cyclist's input power 102 is schematically illustrated as a force conveyed through the drivetrain and commonly measured via one or more strain gauges mounted to the rear wheel hub, bottom bracket/spindle, chainrings and crank spiders, crank arms and/or pedals.

The cyclist's input power works to drive the bicycle and cyclist forward at a given speed (e.g. kinetic energy) 104, which can also be measured using common speed and/or cadence meters, or again via GPS or other positional or motion tracking systems.

Various external forces, however, will naturally impact the user's velocity (and acceleration), such as a rolling resistance 106, an elevation change or slope 108 (which of course acts in the cyclist's favour when rolling downhill), and aerodynamic drag 110. As noted below, while some of these aspects can be measured or calculated directly from sensor readings (e.g. slope or elevation change using onboard inclinometers, gyroscopes, accelerometers, etc.) others, particularly such as aerodynamic drag, must be estimated or solved for using computational techniques as described herein in accordance with different embodiments. Further sensors may nonetheless partake in these calculations, such as wind velocity sensors, for example, which can be used alone or in combination with ground speed readings depending on the sensors used and application at hand, to obtain relative air speed values useful in the computation of aerodynamic drag. Namely, the acquisition or computation of relative air speed values allows for the treatment of real world conditions (as opposed to being limited to still air conditions), for example in gaining access to free stream considerations, and further accentuating scenario's like drafting, for example.

W_{RP}=Crrmgv+mgv sin s+½CdAρvₐᵢᵣ²v

where:

W_{RP} Rider output power (from power meter) (W)

v=Speed (“ground speed”) (m/s)

m=Total mass (rider+bike) (kg)

g=Acceleration due to gravity (9.81 m/s²) (m/s²)

Crr=Coefficient of Rolling Resistance

s=Slope of road (degrees)

a=Acceleration of cyclist (m/s²)

ρ=Air density (kg/m³)

vₐᵢᵣ=Air speed (ground speed+wind speed) (m/s)

CdA=Coefficient of drag×frontal area (m²)

As noted above, parameters such as ground speed, slope of road, air speed, rider output power, acceleration of cyclist and/or road speed can be directly or indirectly measured using appropriate equipment. Other parameters like gravitational acceleration, the mass of the rider and bike, and air density, can be readily input into the system.

It will be appreciated that this model can be altered to add or remove different terms given the application at hand, but also to further refine precision depending on the type of sensor used, its location and mounting mechanism on the user/vehicle, and/or other mechanical considerations at play. For example, a drivetrain efficiency estimate could be incorporated to account for drivetrain losses, for example, when a power measurement is made at the crank, some losses being expected in this context as the wheel is driven.

Using this expression and known, measured or estimated variables, one can then rearrange the terms to solve for acceleration and so also access computed solutions for velocity and position, as follows:

$$a = \frac{{W}_{RP}}{mv} - Crr g - s g - \frac{CdA ρ {v}_{air}^{2}}{2 m} \qquad ( 1 )$$

In order to solve for acceleration, each of the other variables are initialized to realistic values based on gathered data and tests as well as actual measurements for parameters such as air density and rider mass. A differential equation solver can then be used to solve the equation, such as the MATLAB differential equation solver ODE45, though others may readily be employed, as can firmware be deployed for execution by an onboard microcontroller, for example.

In the results described below, the ODE45 solver was run on the input differential equation to produce solved values for acceleration, velocity, and position. Given a perfect data set, the state equation noted above could be solved directly to produce usable results, however, given the inherently noisy nature of the input measurements and the unpredictable variations in unknown variables such as aerodynamic drag variations, further consideration was required to achieve usable results.

For instance, and as noted above, to avoid sensor noise inadvertently misleading results, sensor noise was explicitly accounted for in computing more accurate results. For example, in one embodiment, to model signal noise on sensors such as the speed or power sensor, a zero mean normally distributed random value was added to the known values (i.e. the ODE45 solution for velocity, or initialized power value). In the example provided below, the variance of the signal noise was based on sensor accuracy provided from the manufacturer or observed variations in the case of power sensor data, for example, as previously observed using the Chung method. Below is a chart of model signal noise variance values used for signal noise modeling.

| | Signal Noise Variance | |
|---|---|---|
| Ground Speed Sensor | −/+0.25 | km/h |
| Air Speed Sensor | −/+1 | km/h |
| Slope Sensor | −/+0.5% | Grade |
| Rider Power Sensor | −/+5 | W |

To be able to track the CdA of a cyclist in real time with multiple sensors each with signal noise, a signal filtering solution was pursued. The non-trivial selection and adaptation of a signal filter was required to address, amongst other items: the non-linearity of the state equation at hand (i.e. which includes a quadratic term; the existence of two unknown and immeasurable variables (CdA and Crr) in this particular example, though a greater number of unknown and immeasurable variables may be considered in this or other similar examples within the scope of the present disclosure; the input from multiple (possibly redundant) sensors each having sensor noise; and that the solution should ultimately be able to run in real time on a microcontroller for onboard use.

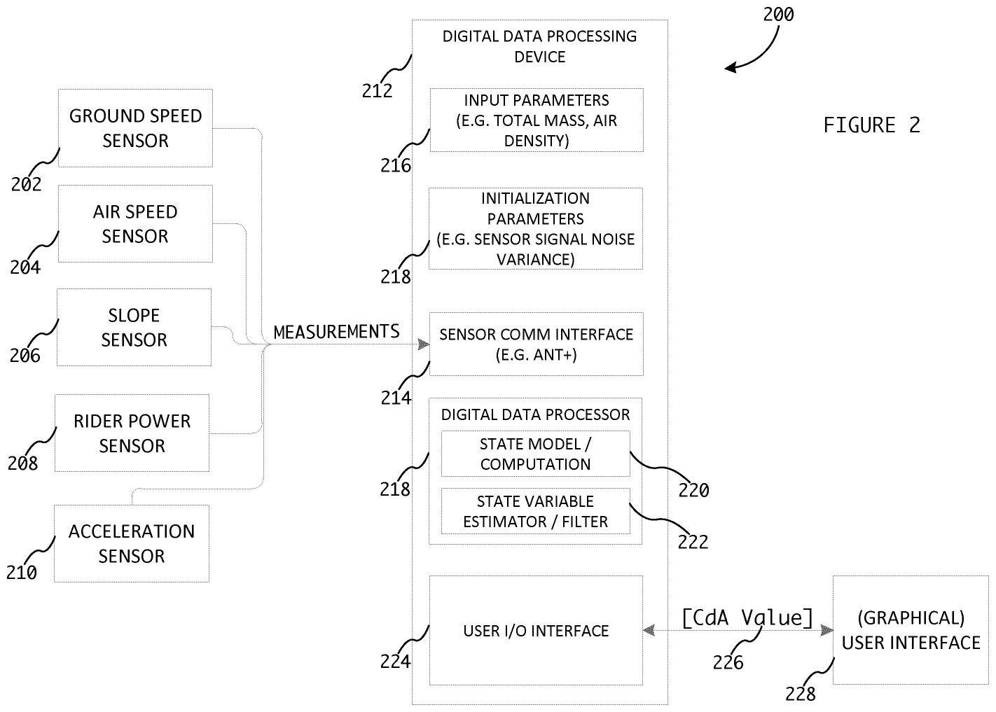

With reference to FIG. 2, a schematic diagram of an aerodynamic drag monitoring system, generally referred to using the numeral 200, will now be illustratively described. In the illustrated embodiment, the system comprises or is adapted to communicatively interface with one or more sensors, and generally a number of such sensors, that can be used as input variables to the cyclist's dynamic state model to estimate and/or compute various unknown variables such as an aerodynamic drag value or indication. In the illustrated embodiment, the system is configured to operate on readings acquired via one or more of a ground speed sensor 202, an air speed (or wind) sensor 204, a slope sensor 206 (e.g. inclinometer(s), gyroscope(s), accelerometer(s), etc.), a rider power sensor 208 and/or an acceleration sensor 210.

Data signals and/or values from each of these sensors are continuously or discretely (e.g. at a set data transfer rate) transferred to a digital data processing device 212 operable to process such signals. While device 212 is illustrated as distinct device, it will be appreciated that various sensors may be integrally formed or associated with the device 212 in a common form factor, as can be provided as a distinct device operatively communicating with one or more external (e.g. proprietary or third party) sensors. Accordingly, the device 212 will include one or more sensor communication interfaces 214 to interface with each of the internal and/or external sensors. Different communication protocols may naturally be invoked to implement this interface, as can different protocols be used for different sensors depending on the nature thereof, whether sensors are integrated or external, wired or wireless, etc. In the illustrated example, the device 212 may take the form of or include a microcontroller that is specifically programmed to interface with each sensor wirelessly using an ANT+ or like protocol, common for athletic/physiologic monitoring sensor communications. Other communication protocols may also or alternatively be considered, such as based on Zigbee, Bluetooth to name a few.

As will be further detailed below, in one embodiment, the digital data processing device 212 is configured to receive and/or store one or more input parameters 216 useful in subsequent computations, such as for example, but not limited to, the total mass of the rider and vehicle, air density, etc. While such input values may be useful, the systems and methods as described herein may also be configured to estimate any of these values which, in some embodiments, may provide for greater accuracy, for example, where a rider gradually consumes water from a mounted water bottle that will inherently reduce the overall weight, and like considerations. The system further initializes a number of initialization parameters 218, such as in the following example, but not limited to, initial sensor and estimated value error ranges (the former generally derived from manufacturer specifications), directional tracking boundaries (discussed below) useful in mitigating potential windup issues in tracked/estimated values, and identification of which parameters are to be influenced by actual sensor readings as opposed to pure estimated values.

Based on the initialized and input parameters, and the input of sensor data, a digital data processor 218 may be operated, based on a stored state model and computational process 220, to act on these values to filter and estimate various state variables 222 of interest. Processor outputs may then be directed to an input/output interface 224 to provide an output indication as to an unknown state variable of interest, such as a CdA value 226, index or indicia, for example. Process outputs may be stored and managed locally for further processing, output on a local (graphical) user interface, or again relayed via wired or wireless communications to an external or third party interface 228.

In one embodiment, the digital data processor 218 is configured to implement an adapted Extended Kalman Filter process at 222, which was configured to address the particular conditions at hand, namely to integrate known measurements over time, each containing statistical noise and/or other inaccuracies, and to produce estimates for unknown variables such as CdA and/or Crr by estimating a joint probability distribution over the variables for each timeframe. The fundamental principles of Kalman and Extended Kalman Filters are well known in the art and therefore need not be replicated herein. Detailed descriptions can be found, for example, in the following references, the entire contents of which are hereby incorporated herein by reference (H. M. Paul Zarchan, Fundamentals of Kalman Filtering: A Practical Approach, American Institute of Aeronautics and Astronautics, 2000; H. S. Liyu Cao, “The Kalman Filter Based Recursive Algorithm: Windup and Its Avoidance,” in Proceedings of the American Control Conference, Arlington, Va., 2001).

One drawback of the standard Kalman filter is that it is not able to predict accurately for non-linear state equations, which is required in this particular embodiment. This was addressed by adapting an Extended Kalman Filter (EKF) which adapts the standard Kalman filter to work with non-linear state equations, as detailed below.

Another issue with both the standard and Extended Kalman filters is windup where the algorithm no longer responds to changes after it has initially found the unknown variables' actual values. This issue can be of particular concern when considering CdA variations which, as noted above, are at times aptly modeled by a step function as the user abruptly changes position after a long time riding in one particular position, for example. Accordingly, windup could inaccurately home in on a constant CdA value, or other parameter such as Crr if road/tire conditions change, and ignore or at first misinterpret a relatively sudden step change. Doing so would typically result in a prohibitively slow response to CdA changes (demonstrated below) which would counter the interest in establishing real-time CdA monitoring and reporting. As detailed below, windup issues noted with the EKF were addressed, in one embodiment, using “Directional Tracking” in which a tuning matrix is added to the standard algorithm in which specific variables can have the windup removed. For instance, in some embodiments, a lower bound can be applied to the error covariance, effectively applying a lower bound on the Kalman gain for certain variables to track unpredictable variations (e.g. abrupt change in aerodynamic drag conditions).

In the following example, an Extended Kalman Filter with Directional Tracking was utilized to dynamically estimate accurate CdA values for a cyclist. In this example, the EKF uses a state matrix (X) consisting of each of the variables that are to be tracked by sensors as well as predicted by the filter. Each of the variables in the state space matrix for the cyclist system is summarized in the following table.

State Space Variables

| Measured | Predicted |
|---|---|
| Ground Velocity (v) | Coefficient of Drag × |
| Wheel Speed sensor | Frontal Area (CdA) |
| Slope of Road (s) | Coefficient of Rolling |
| Accelerometer/Gyro | Resistance (Crr) |
| Wind Velocity (wv) | |
| Pitot Tube/Differential Pressure Sensor | |
| Rider Output Power (RP) | |
| Power Meter | |
| Acceleration of Cyclist (a) | |
| Accelerometer | |

To linearize the non-linear state equation (1) above, the time derivative of the state space is taken, thus the Jacobian is taken of the state space, whereby a matrix of partial derivatives is taken to determine the system dynamics matrix (F) as follows.

$$F = J [ Δ \frac{\partial \hat{X}}{\partial t} ]$$

In this example, the system dynamics matrix is used to take the first two terms of the Taylor series expansion of the fundamental matrix (Φ) where I is the identity matrix, as follows:

$$Φ ( t ) = I + \frac{Ft}{1 !}$$

A two term Taylor series approximation is used as higher order approximations tend to show negligible improvement in filter performance. In this exemplary implementation, the EKF includes a continuous process noise matrix (Q(t)) which corresponds to which state variables are being predicted by the system and includes process noise (Φₛ) on those variables. A discrete process noise matrix (Qₖ) is used to account for any accuracy differences between the state equation and the actual physics of the system. The discrete process noise matrix accounts for the process noise between sampling times (Tₛ) and can be calculated using the following relation:

$$Q = {\int }_{0}^{{T}_{s}} Φ ( τ ) Q {Φ}^{T} ( τ ) d τ$$

In this system, the inclusion of the discrete process noise matrix and whether or not it should be set to zero is discussed further below.

Next, a measurement matrix (H) is initialized to correspond to what state variables have sensor readings. The measurement matrix has as many rows as there are sensor readings with ones being placed in the column position that's the same as the system dynamics matrix position for the variables that have sensor readings.

The discrete measurement noise matrix (Rₖ) is the expected mean noise on each of the sensors, squared. This is initialized using the manufacturers expected accuracy (i.e. variance) for each state variable position with sensor readings similar to the measurement matrix. These values are not generally changed throughout the algorithm, though could be manually adjusted as needed in some embodiments to refine system performance or address noted variations in sensor accuracy.

A covariance matrix of errors (Pₖ) is also initialized using the same expected sensor variance squared values from the measurement noise matrix for variables that have sensor readings, and for variables without sensors the expected error range can be estimated and used accordingly. As the covariance matrix is updated at each step with new sensor readings, initial values should generally be on the larger side. If the covariance is initialized at zero for all variables the filter will not track as it sees the covariance errors are all zero meaning it's perfectly tracking. The subscript “k” indicates whether a matrix is from the current iteration of the algorithm or from the previous iteration “k−1”.

The directional tracking tuning matrix (V) is initialized and held constant throughout the iterative steps of the filter process. The tuning matrix prevents filter windup where, as noted above, the filter would ultimately disregard new sensor readings and otherwise rely fully on its prediction step even if there have been significant changes to the system requiring adaptation, such as sudden and significant changes in the user posture or form that would invoke a noticeable and relevant difference in CdA.

Once each of the previous matrices have been initialized, they are used in known Riccati Equations which are continuously calculated at each time step for the process. The Kalman gain (Kₖ) is calculated and represents whether the process determines that it's prediction is more reliable or the current sensor reading is. This is done using the covariance matrix of errors as a constantly updating matrix, which corresponds to the errors between the algorithm's predictions and the sensor readings at the previous time step.

The calculation of the Kalman gain is broken into two steps for ease of calculation as follows. First the covariance matrix representing errors in the state estimates before an update is calculated (Mₖ). The directional tracking tuning matrix is included in this step of calculation to stop the Kalman gain (Kₖ) calculated next from going to zero.

Mₖ=ΦₖPₖ₋₁Φₖ^{T}+Qₖ+ψ

Kₖ=MₖH^{T}(HMₖH^{T}Rₖ)⁻¹

Next the process uses the Euler method to solve the governing differential equation in Equation (1) over the sample time of the sensors (e.g. 1 second sample rate). The step size chosen for the Euler integration was 0.001 seconds as decreasing the integration step size lower than that is expected to provide negligible filter performance benefit while increasing computational load substantially. Clearly, other integration times can be used depending on the application at hand and the sensitivity and accuracy required.

The Euler integration provides predictions for acceleration and velocity of the cyclist, only, as there are no governing equations for independent variables such as rider power or slope.

Next, the process' filtered values (\hat{X}) are updated using the residual difference between the Euler predicted variables (X̅) and the current noisy sensor reading (X^{*}) and the Kalman gain matrix. For the variables that do not have predicted values like rider power and slope they just calculate the residual based off the previous filtered value (\hat{X}ₖ₋₁) and the new sensor reading (Xₖ^{*}). This is also where output parameters like CdA are computed. The Kalman gain being multiplied by the residual is where the algorithm is weighting the sensor reading versus the Euler prediction which gets reflected in the filtered values.

\hat{X}ₖ=X̅ₖ+Kₖ(Xₖ^{*}−X̅ₖ)

After the filtered state variables are updated, the covariance matrix of errors is updated to reflect the past sensor readings as well as the new estimates, which provides another potential benefit in allowing not only CdA estimates to be accurately produced, but also providing user access to error estimates for such values.

Pₖ=(I−KₖH)Mₖ

This final step completes one iteration of the filtering process, which is completed between each sample time of the sensors.

By running the filtering process using modeled sensor noise data sets, the filter performance is able to be observed and the root mean squared error (RMSE) accuracy for the process calculated for different conditions and tuning parameters. The RMSE indicates the spread of the filtered values (\hat{X}ᵢ) versus the actual values (Xᵢ), therefore a lower RMSE generally indicates accurate tracking performance.

$$RMSE = \sqrt{\frac{{\sum }_{i = 1}^{n} {( {X}_{i} - {\hat{X}}_{i} )}^{2}}{n}}$$

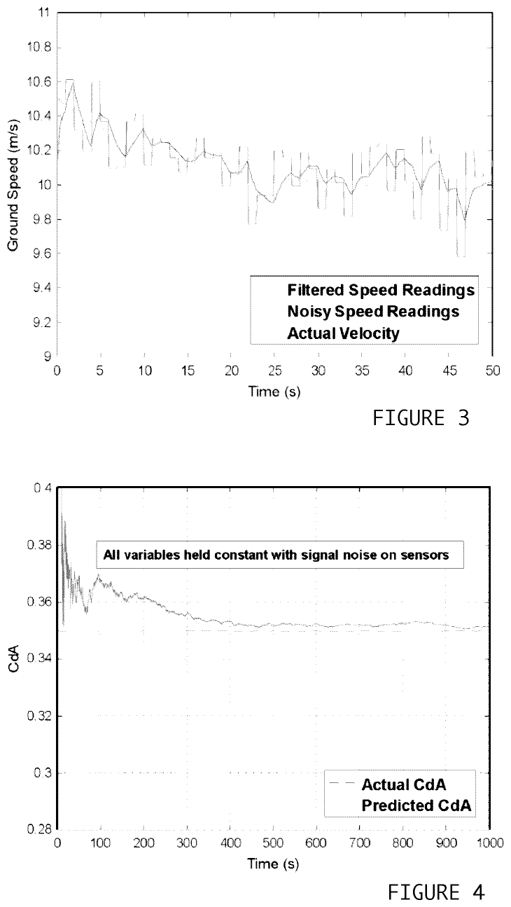

The filter performance for reducing RMSE can be observed when tracking the velocity of the cyclist. FIG. 3 shows a model of a cyclist with noisy speed sensor readings and the EKF filtering of the readings to track the actual velocity of the cyclist. In this example, the speed sensor readings are updated at 1 Hz which corresponds with standard bicycle speed sensor update rates.

The RMSE for the unfiltered sensor readings is 0.16 m/s whereas the EKF filtered values have an RMSE of 0.08 m/s indicating that the filter is indeed improving the tracking accuracy over just using raw sensor readings.

With reference to FIG. 4, the CdA of a cyclist is predicted, whereby the filtering process converges on a constant CdA value closely even with noise on each sensor reading. This is done without the directional tracking tuning matrix included and a constant rider power, no slope to the road and no head/tail wind speed values. For these ideal system conditions, the filter tracks the CdA with an RMSE of 0.004 (±1%). Although these conditions are not representative of real world conditions it illustrates the filter is able to track the CdA accurately with noisy sensor readings.

In order to more accurately model a cyclist riding in real-world conditions and thus validate the herein-described approaches, some of the variables were made to oscillate sinusoidally (in the case of rider power) or have a step function (in the case of CdA). A sinusoidal oscillation on variables such as rider power or slope better model the true nature of a cyclist riding on open roads since a cyclist is never able to hold exactly the same power and roads are never perfectly flat. Using a step function to model CdA shows how a rider would stay in one position for a long period of time then change at an unknown point to a different position with an unknown CdA, a change the system is configured to track and compute to report back to the user or coach for consideration.

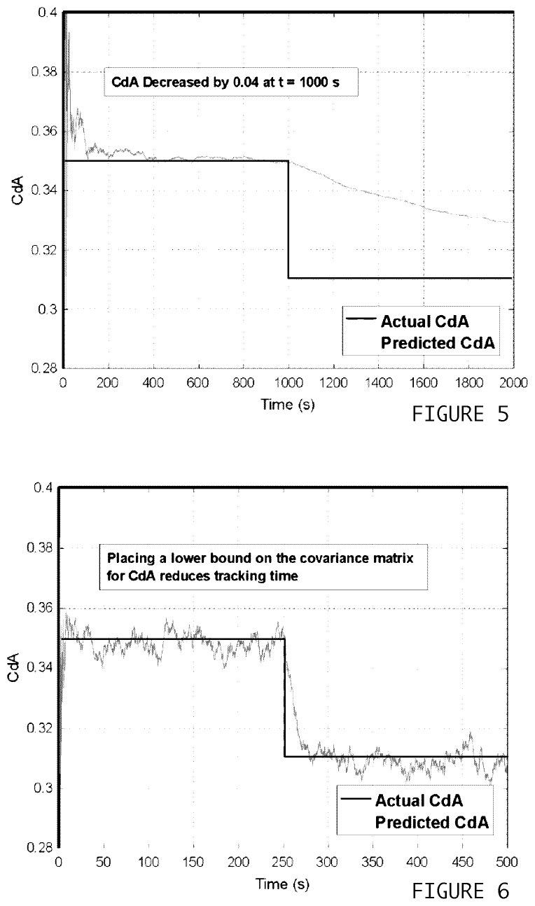

With reference to FIG. 5, the variables were held constant from the results shown in FIG. 4 and directional tracking was withheld while the modeled CdA was modified from a constant value to a step function thus representing a sudden change in CdA at an arbitrary time. For example, this could model a rider moving from one position to another while riding. Although the filter appears to be slowly adjusting to the new value, its response time is much too slow (>15 minutes). This demonstrates how the standard EKF algorithm is not well suited to tracking the cyclist's CdA as this type of CdA change is very common for cyclists moving between positions (similar positional and related CdA changes are also expected for other athletic activities).

By including the directional tracking tuning matrix in the algorithm and effectively placing a lower bound on the error covariance matrix the response time of the filter to the change in rider position is significantly reduced to approximately 30 seconds. FIG. 6 shows the filter's performance improvement when including directional tracking.

With the directional tracking tuning matrix included the RMSE is ˜0.01 (±3%). While the filter tracks the CdA much more responsively, the variability of the predicted CdA over the substantially constant sections increases (i.e. the CdA predictions appear noisier). This is a tradeoff between the response time and stability of the prediction that can be refined by adjusting the tuning matrix. Other potential solutions to this issue is performing a rolling average on the filtered CdA values to remove some of the variation while keeping the quick response time to any CdA changes.

The same filter windup tracking issue that occurs with a varying CdA can also occur with tracking time-varying rider power. For example, gathered data has shown that even when a cyclist is trying to maintain a consistent power there is still a variation of around ±10-15 watts due to the rider constantly adjusting to changing road conditions like hills and wind gusts. To model and study this variation in the theoretical model the rider's power was oscillated in a sinusoidal pattern with an amplitude of 10 watts and a mean of 250 watts.

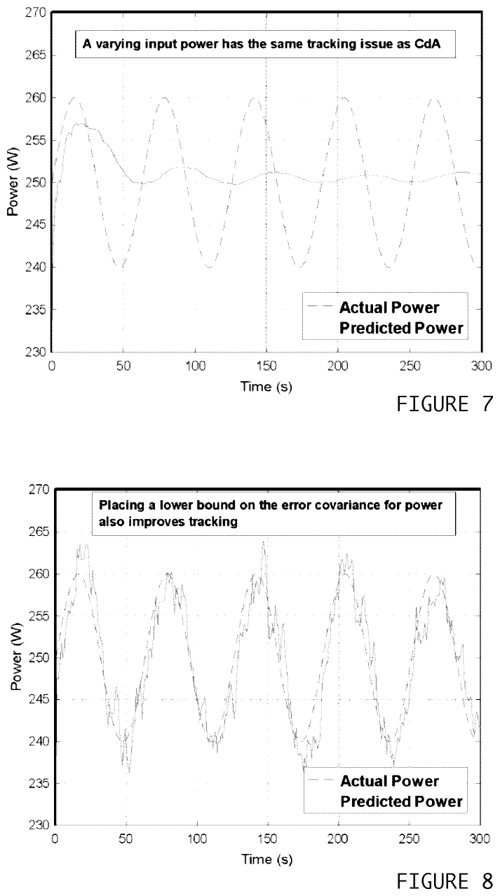

FIG. 7 shows the standard EKF filter attempting to track the sinusoidal power curve but it eventually approaches a steady state at the mean power of 250 watts. On the other hand, and similarly to the CdA tracking noted above, FIG. 8 shows that the inclusion of the directional tracking tuning matrix makes the filter track much more closely to the actual power although with more variability (i.e. appears more noisy).

While the above presents some examples as to how the system can be configured to manage various noisy (and optionally redundant or interchangeable) input measurements to accurately estimate unknown variables, such as CdA or like aerodynamic drag variables, other similar techniques may also be considered, as can additional data processing and/or filtering steps employed to refine output results. For example, certain data inputs may be subjected to pre-filtering routines to reduce sensor noise impacts on the overall process without significantly reducing accuracy, if not increasing such accuracy and system stability. For example, while input readings for slope measurements may be inherently noisy depending on the technology used to make such measurements, slope variations are generally expected to be particularly gradual. Accordingly, a rolling average or Butterworth filter may be applied to such readings before being input for overall processing.

Likewise, while an EKF is described in the exemplary embodiment detailed above, other types of filter may also be considered, such as an unscented KF and/or similar or related routines and subroutines. These and other such considerations should be considered to fall within the general scope and nature of the present disclosure.

As noted above, embodiments of the herein described embodiments may provide for flexibility in the number of sensors being used, including redundancy of sensors (e.g. wheel speed, GPS; GPS, slope, magnetometer and pressure; etc.). Such sensor fusion or redundancy may allow, for example, to increase overall accuracy but also, optionally, to maintain calculations if one of the sensor fails in operation.

In some of the noted examples, the systems and methods may be adapted to include different numbers of parameter estimates and/or further expand the number and type of terms included in the dynamic model's governing equation. For example, the system could be configured to estimate the mass of rider and bike as it changes over the ride, add terms for drivetrain efficiency, drag dependency with yaw angle, etc.

Furthermore, as error estimates can be computed, they can also be output to further enhance interpretation of output result accuracy and reliability. Error bounds can also be set and adjusted to improve overall accuracy, responsiveness or like parameters.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

1. A system for monitoring aerodynamic drag variations in line with a user's path of motion, the system comprising:
a motion sensor and an aerodynamic sensor fixedly mountable in relation to the user and operable to each measure a respective sensor value representative of a motion of the user and a local airflow over time, wherein each said sensor value is associated with a respective sensor noise variance;
a digital data storage medium having stored thereon:
a digital motion dynamic model for the user in motion, wherein said model defines respective measured input variables associated with each said sensor value and a predicted aerodynamic drag variable at least partially predictable from said respective measured input variables via said model; and
preset initialization parameters representative of the system and at least comprising a stored value representative of each said respective sensor noise variance;
a digital data processor operable to iteratively process each said measured sensor value against said model to output a predicted value for said predicted aerodynamic drag variable over time while accounting for each said respective sensor noise variance.

2. The system of claim 1, wherein said digital processor is operable to iteratively process said measured sensor value by implementing an Extended Kalman Filter.

3. The system of claim 2, wherein said Extended Kalman Filter is implemented with Directional Tracking.

4. The system of claim 1, wherein the user's path of motion is defined while performing an athletic activity, and wherein said dynamic model is specifically defined for said athletic activity.

5. The system of claim 1, wherein said athletic activity is cycling.

6. The system of claim 5, wherein said dynamic model defines dynamic variables associated with each of rider input power, kinetic energy, rolling resistance, elevation change and aerodynamic drag, and wherein the system comprises multiple sensors each fixedly mountable in relation to the user in motion and operable to produce values representative of a rider power, a user velocity, an inclination and an air velocity.

7. The system of claim 1, wherein said athletic activity is skiing or rowing.

8. The system of claim 4, wherein said dynamic model comprises defined dynamic variables associated with at least each of user input power and aerodynamic drag.

9. The system of claim 4, wherein the system is operable to produce values representative of at least a user power, a user velocity, and an air velocity.

10. The system of claim 9, wherein the system is further operable to produce values representative of an inclination.

11. A non-transitory computer-readable medium having computer-executable instructions stored thereon to monitor aerodynamic drag variations on a user in motion that, upon implementation by a digital data processor:
receive as input a sensor value representative of a displacement of the user in motion over time, wherein said sensor value is associated with a sensor noise variance;
iteratively process said measured sensor value against a digital motion dynamic model for the user in motion, wherein said model defines a measured input variable associated with said sensor value and a predicted aerodynamic drag variable at least partially predictable from said measured input variable via said model, so to output a predicted value for said predicted aerodynamic drag variable over time while accounting for said sensor noise variance.

12. The computer-readable medium of claim 11, wherein said instructions, when implemented by said digital processor, further iteratively process said measured sensor value by implementing an Extended Kalman Filter.

13. The computer-readable medium of claim 12, wherein said Extended Kalman Filter is implemented with Directional Tracking.

14. The computer-readable medium of claim 11, wherein the user's path of motion is defined while performing an athletic activity, and wherein said dynamic model is specifically defined for said athletic activity.

15. The computer-readable medium of claim 15, wherein said athletic activity is cycling, and wherein said dynamic model defines dynamic variables associated with each of rider input power, kinetic energy, rolling resistance, elevation change and aerodynamic drag, and wherein the instructions are implementable to produce values representative of a rider power, a user velocity, an inclination and an air velocity.

16. The computer-readable medium of claim 14, wherein said dynamic model comprises defined dynamic variables associated with at least each of user input power and aerodynamic drag.

17. The computer-readable medium of claim 14, wherein the instructions are implementable to produce values representative of at least a user power, a user velocity, and an air velocity.

18. A computer-implemented method, to be implemented by one or more digital processors, to automatically monitor aerodynamic drag variations on a user in motion, comprising:
receiving as input a sensor value representative of a displacement of the user in motion over time, wherein said sensor value is associated with a sensor noise variance; and
iteratively processing said measured sensor value against a digital motion dynamic model for the user in motion, wherein said model defines a measured input variable associated with said sensor value and a predicted aerodynamic drag variable at least partially predictable from said measured input variable via said model, so to output a predicted value for said predicted aerodynamic drag variable over time while accounting for said sensor noise variance.

19. The computer-implemented method of claim 18, wherein said iteratively processing comprises iteratively processing said measured sensor value by implementing an Extended Kalman Filter.

20. The computer-implemented method of claim 19, wherein said Extended Kalman Filter is implemented with Directional Tracking.
